(19) United States
(12) Patent Application Publication
(10) Pub. No.: US 2010/0077829 A1
(43) Pub. Date: Apr. 1, 2010

(54) LOW DIFFERENTIAL PRESSURE MONITORING SYSTEM FOR ROOMS

(76) Inventors: Anthony Batista, Ashby, MA (US); Gino Amaro Pinto, Milford, MA (US); Terrence J. Troyer, Hudson, MA (US); Shawn O. Henry, Pepperell, MA (US); Craig Surprise, Acton, MA (US); Eric C. Beishline, Marlbourough, MA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/348,277

(22) Filed: Jan. 3, 2009

Related U.S. Application Data
(60) Provisional application No. 61/101,481, filed on Sep. 30, 2008.

(51) Int. Cl. G01N 7/00; G01L 27/00

(52) U.S. Cl. 73/1.57; 73/31.01; 702/98

(57) ABSTRACT

A pressure monitoring apparatus (10) including features that simplify in-situ calibration procedures. A pressure monitoring module (12) of the apparatus is coupled to external pressure lines (14, 16) and an external electrical interface (24) via an easily removable monitoring module plug (32). The monitoring module can be disconnected from the pressure lines and external interface and then connected to a portable calibration module (42) by simply replacing the monitoring module plug with a calibration module plug (50). The calibration module plug provides an electro-pneumatic interface between the monitoring module and the calibration module. The monitoring module may be electronically interrogated and automatically calibrated via a processor of the calibration module. The monitoring module plug may be inserted onto the calibration module plug to provide actual system pressures to the now-calibrated apparatus for final documentation. Touch-screen (28) interface with the monitoring module provides an one-touch calibration of Zero and Span.

This application claims benefit of the 30 Sept. 2008 filing date of U.S. provisional application 61/101,481.

### FIELD OF THE INVENTION

This invention relates generally to the field of fluid pressure monitors for ambient air conditions for rooms, and to the calibration of such monitors.

### BACKGROUND OF THE INVENTION

Fluid pressure monitors are used in a large variety of applications over a wide range of pressures and with varying requirements for accuracy. Very low differential ambient air pressures, on the order of a full scale range of 0.1 inch of water or less, must be measured with a high degree of accuracy in applications such as manufacturing clean rooms, medical isolation wards, and various HVAC systems. Periodic calibration of such devices is required to ensure and to document their proper operation.

U.S. Pat. No. 5,693,871, incorporated by reference herein, describes a pressure generator that may be used to calibrate differential pressure transducers that operate at very low differential pressures.

U.S. Pat. No. 6,584,421, also incorporated by reference herein, describes an instrument calibration device that incorporates a portable computer as its user interface in order to simplify the use of the device for calibrating a variety of instruments and for recording the results of such calibrations.

### BRIEF DESCRIPTION OF THE DRAWINGS

The invention is explained in the following description in view of the drawings that show:

FIG. 1 is a schematic illustration of a room pressure monitoring apparatus in an operational configuration.

FIG. 2 is a schematic illustration of the room pressure monitoring apparatus of FIG. 1 in a calibration configuration including a portable calibration module.

FIG. 3. is a schematic illustration of the room pressure monitoring apparatus of FIG. 2 in a further calibration configuration.

FIG. 4 is a Starting screen display of the monitoring module of the room pressure monitoring apparatus of FIG. 1.

FIG. 5 is a Menu screen display of the monitoring module of the room pressure monitoring apparatus of FIG. 1.

FIG. 6 is a Calibration screen display of the monitoring module of the room pressure monitoring apparatus of FIG. 1.

### DETAILED DESCRIPTION OF THE INVENTION

The assignee of the present invention provides calibration equipment for instrument calibration service that satisfies ISO documentation standards requirements, that is performed in compliance with ANSI/NCSL Z540-1-1994, and that is certified per NIST traceable primary standards. For the owners and operators of large numbers of pressure transducers, on-site calibration may be an economically viable alternative to shop-based calibration. Portable calibration devices, such as the Model 869 Micro-Cal™ calibration system sold by the assignee of the present invention, provide the capability to deliver a highly accurate calibration source directly to the location of a pressure monitoring installation. A pressure transducer is removed from its operating position, inserted into the Model 869 Micro-Cal™ calibration system, and then reinstalled immediately following the calibration procedure, thereby avoiding the downtime and expense associated with shipment to a central calibration service location.

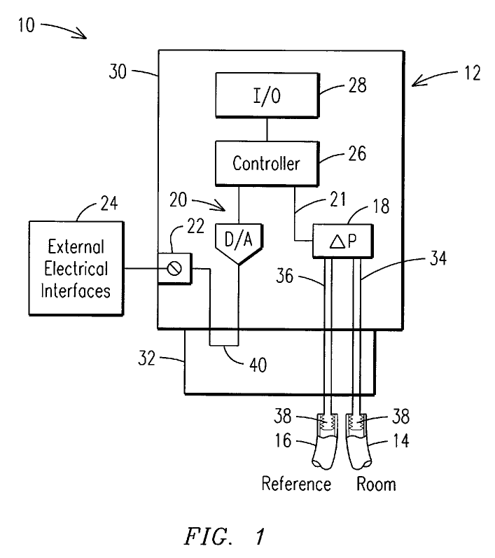

FIGS. 1-3 are schematic illustrations of an improved pressure monitoring apparatus 10 in various configurations, such as may be used for low differential pressure applications for example. A monitoring module 12 of the pressure monitoring apparatus 10 is illustrated in FIG. 1 in an operational configuration as it functions as an active transducer in an operating system, such as a room pressure monitoring application. A monitored pressure (room pressure) and a reference pressure are provided to the device by respective room and reference pressure lines 14, 16. A differential pressure sensor 18 of any known type, such as capacitive, inductive, strain gauge for example, converts the difference in pressure between the two lines 14, 16 into an electrical signal 21, such as a frequency output proportional to measured pressure. An electrical terminal 22 is provided for removable electrical connection of the appropriate monitoring module electrical connections 20 to various external electrical interfaces 24, such as a power supply, remote display, remote controller, etc. For simplification of the drawings, electrical connections are illustrated in these figures as single lines that may represent a plurality of power, control and/or signal functions as known in the art. A controller 26, such as any known microprocessor and memory (EPROM), provides the appropriate control, memory and processing functions and operatively interconnects the various components of the monitoring module 12. User interface may be provided by an input/output device or devices such as touch screen 28. All of these components may be supported directly or indirectly by a frame 30 that is mountable to a wall, rack or other desired support structure or surface.

The apparatus 10 also includes a monitoring module plug 32 that may be selectively attached or removed from the monitoring module 12. The monitoring module plug 32 provides a plug-in connect/release fluid connection between the room and reference pressure lines 14, 16 and respective pressure ports 34, 36 of the differential pressure sensor 18. The pressure lines 14, 16 may be installed over barbed tips to provide a tight fluid seal and strong mechanical connection which need not be disturbed during subsequent calibration procedures. The fluid seal between the monitoring module plug 32 and the monitoring module 12 may include a flexible gasket or O-ring (not shown). Additionally, the plug may be held in place once installed on the monitoring module 12 by friction or by any type of known locking device, such as screws or clips for example (not shown).

The monitoring module plug 32 may also include electrical conductor(s) that provide plug-in connect/release electrical continuity between the electrical terminal 22 and the various other electrical connections 20 of the monitoring module 12 when the plug 32 is installed on the monitoring module 12. One embodiment of the monitoring module plug 32 was made by modifying a standard D-sub electrical connector to include fluid passages in the location normally occupied by the screw fasteners. Accordingly, when the monitoring module plug 32 is disconnected from the monitoring module 12/frame 30, the pressure ports 34, 36 and the electrical connections 20 are disconnected from the respective pressure lines 14, 16 and external electrical interfaces 24.

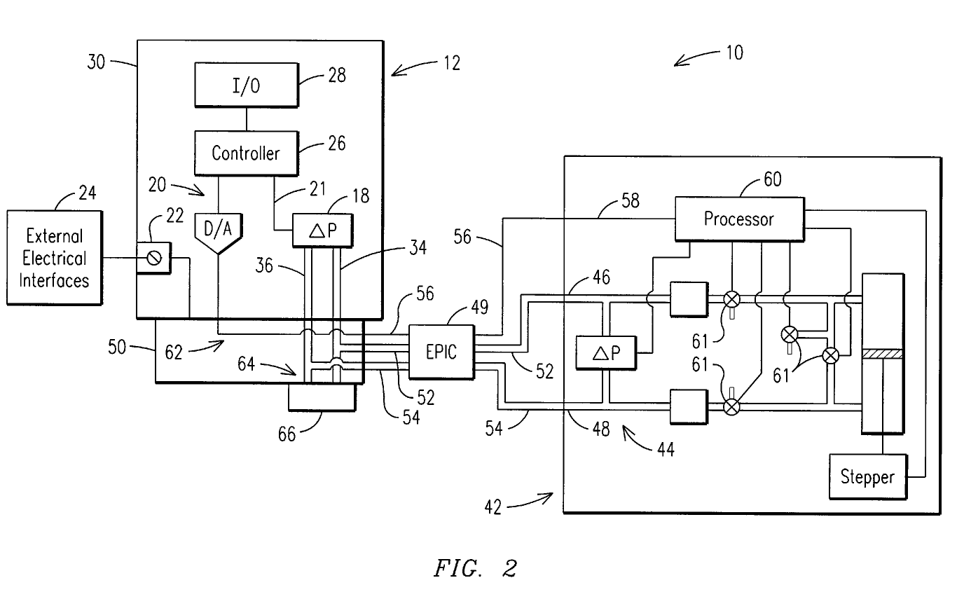

FIG. 2 illustrates the pressure monitoring apparatus 10 in a calibration configuration where the monitoring module plug 32 has been removed, thereby making the pressure ports 34, 36 and the electrical connections 20 available for connection to a portable calibration module 42. The calibration module 42 includes a calibration pressure source 44 such as the pressure generator described in U.S. Pat. No. 5,693,871 discussed above. The calibration pressure source 44 provides precise, controllable and repeatable fluid pressures to pressure outlets 46, 48. These pressure outlets are selectively fluidly connected to the monitoring module pressure ports 34, 36 by an electro-pneumatic interface 49. The electro-pneumatic interface 49 is connected at its proximate end to the calibration module 42 in any desired manner. At its distal end, the electro-pneumatic interface 49 may include a calibration module plug 50 adapted for selective installation on the monitoring module 12/frame 30 in place of the monitoring module plug 32 to enable calibration of the pressure sensor 18. The electro-pneumatic interface 49 includes fluid passages 52, 54 for interconnecting the monitoring module pressure ports 34, 36 with the calibration module pressure outlets 46, 48, and it also includes electrical conductor(s) 56 for interconnecting calibration module electrical connections 58 with the monitoring module electrical connections 20. Here again, to simplify the drawings, all power, control and signal conductors are graphically illustrated as a single line. Also, no power supply is illustrated, but one skilled in the art will appreciate that a battery pack or other source of power would be associated with the portable calibration module 42. The electro-pneumatic interface 49 may be fabricated as a single integrated Electro-pneumatic Interface Cable (EPIC), although one skilled in the art will recognize that multiple cables/plugs may be used in other embodiments to accomplish similar functions.

As can be seen in FIG. 2, the external electrical interfaces 24 are isolated from the monitoring module in the calibration configuration, and the monitoring module electronic components 26, 28 are interconnected with the calibration module processor 60. Interrogation, control and operation of the monitoring module 12 may be accomplished via the calibration module 42 in this configuration. For example, an EPROM of controller 26 may be interrogated by the calibration module 42 to identify the type of monitoring module 12 that is connected to the EPIC, whereupon data related to that identity may be recalled from memory and used by the calibration module 42, such as for automatically selecting an appropriate full scale pressure for the calibration process, or an accuracy code, or a serial number as examples. The processor 60 may then execute programmed instructions for automatic calibration of the monitoring module 12, such as:

apply a zero differential pressure across the pressure outlets 46, 48 (thereby across the pressure ports 34, 36 via fluid passages 52, 54);

setting a resulting output of the pressure transducer 18 to a desired zero value by responsively programming data in EPROM of controller 26;

applying the previously determined full scale pressure across the pressure outlets 46, 48; and

setting a resulting output of the pressure transducer 18 to a desired full scale value by responsively programming data in EPROM of controller 26.

The zero differential pressure may be accomplished within the calibration module 42 by appropriate control of valves 61 to shunt both sides of the calibration pressure source 44 to atmosphere.

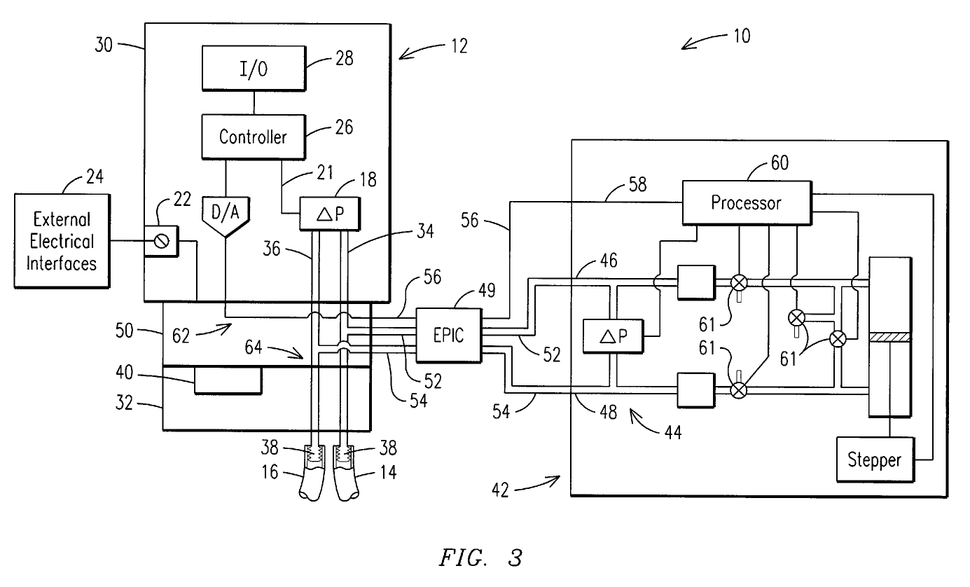

As can be seen in FIG. 2, the calibration module plug 50 includes monitoring module interface connections 62 for selective connection with the monitoring module 12. In addition, the calibration module plug 50 may have operating system interface connections 64 on an opposed side for selective connection with the operating system fluid connections via the monitoring module plug 32, as illustrated in FIG. 3. In the configuration of FIG. 2 during the above-described calibration steps, the operating system interface connections 64 are closed with a blank plug 66. After the calibration steps have been completed, the blank plug 66 may be removed and replaced with the monitoring module plug 32 previously described with reference to FIG. 1. This allows the pressure ports 34, 36 as well as the calibration module pressure outlets 46, 48 to be exposed to pressure generated in the monitored operating system and delivered by the room and reference pressure lines 14, 16. This configuration is useful for comparing and recording data generated by the pressure sensor 18/monitoring module 12 and data coincidently generated by the calibration module 42 in response to actual system pressures delivered via the room and reference pressure lines 14, 16. In this manner, the monitoring module 12, the calibration module 42 and the system operator's supervisory monitoring system may be reconciled.

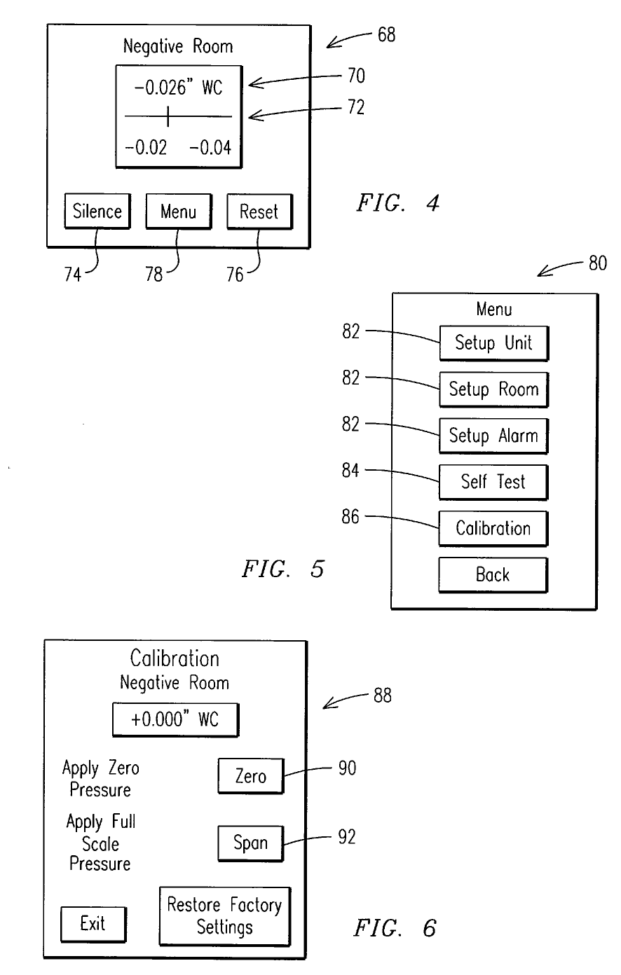

The pressure monitoring apparatus 10 enables calibration of the monitoring module 12 without removing the device from its operational location, and without removing any hard wired connection from the electrical terminal 22, and without removal of tubing for pressure lines 14, 16 from the monitoring module 32. Furthermore, the touch screen user interface device 28 provides further capability for in-situ calibration of the device. Programmed code may be executed by the controller 26 for providing a simplified user interface for calibration via the touch screen 28. FIG. 4 illustrates a Starting Screen display 68 as may be provided during normal operation of the pressure monitoring apparatus 10. The real-time measured pressure may be displayed as a numeric value 70 and/or as a graphical presentation 72 showing the location of the real-time actual value in relation to the alarm setpoint limits. The real time display of the entry door status may also be displayed via the touch screen display 28 by a text message or by using color change indication. In addition, Silence and Reset buttons 74, 76 may be provided for the operator to use in response to an alarm. The alarm may be provided by an auxiliary device, such as a sound generating device and/or a light emitting device, and/or the alarm may be displayed on the touch screen 28 via a color indication, flashing display or other manner. A Menu selection 78 may also be provided on the Starting Screen display 68.

In response to a touch of the Menu selection 78, a Menu Screen 80 is displayed as illustrated in FIG. 5. The Menu Screen 80 includes Setup selections 82, a Test selection 84 and a Calibration selection 86.

In response to a touch of the Calibration selection 86, a Calibration Screen 88 is displayed, as illustrated in FIG. 6. The Calibration Screen 88 includes a Zero selection 90 and a Span selection 92. Upon removal of the monitoring module plug 32 from the frame 30 (thereby exposing the pressure ports 34, 36 to the same atmospheric pressure and a zero pressure differential) and in response to a touch of the Zero selection 90, the controller 26 may be programmed to set the output of the pressure sensor 18 to a desired zero value (e.g. 0 volts DC or 4 ma, for example) by appropriate data recordation in the controller EPROM. A known full scale pressure may then be applied to the measured room pressure port 34, and in response to a touch of the Span selection 92, the controller 26 may similarly set the output of the pressure sensor 18 to a desired full scale value (e.g. 10 volts DC or 20 ma, for example). Thus, calibration of the unit is accomplished in a rapid and convenient manner without the removal of the monitoring module 12 from its operating location.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A pressure monitoring apparatus for ambient air conditions in a room comprising:
a frame;
a pressure sensor supported by the frame and comprising measured and reference pressure ports and electrical connections;
electrical terminals supported by the frame for interconnecting the pressure monitoring apparatus to external electrical interfaces;
at least one monitoring module plug selectively connectable to the frame and providing plug-in connect/release interconnectivity between the measured and reference pressure ports and respective measured and reference pressure lines, and when connected to the frame, providing continuity between the electrical terminals and the pressure sensor electrical connections;
wherein when the monitoring module plug is disconnected from the frame, the sensor pressure ports and electrical connections are disconnected from the respective pressure lines and external electrical interfaces and are available for connection to a portable calibration module;
a touch screen supported by the frame; and
a controller supported by the frame and operatively interconnecting the pressure sensor, the touch screen and the electrical terminals.

2. The apparatus of claim 1, further comprising:
code executable by the controller for sequentially displaying a plurality of displays on the touch screen in response to respective user inputs provided via the touch screen, wherein;
a starting screen comprises a display of pressure measured by the pressure sensor and a Menu selection; and
in response to a touch of the Menu selection, a Menu Screen is displayed comprising Setup, Test and Calibration selections.

3. The apparatus of claim 2, further comprising code executable by the controller wherein:
in response to a touch of the Calibration selection, a Calibration Screen is displayed comprising Zero and Span selections;
in response to a touch of the Zero selection after removal of the monitoring module plug from the frame, a zero pressure value is automatically calibrated in the apparatus; and
in response to a touch of the Scan selection after the application of a full scale pressure to the measured pressure port, a scan value is automatically calibrated in the apparatus.

4. The apparatus of claim 1, further comprising:
a portable calibration module comprising differential pressure outlets and an electrical connection;
an electro-pneumatic interface comprising measured and reference fluid passages and at least one electrical conductor, the electro-pneumatic interface being connected at a proximate end to the calibration module pressure outlets and electrical connection and comprising at least one calibration module plug at a distal end, the calibration module plug being adapted for selective installation on the frame in place of the monitoring module plug for calibration of the pressure sensor.

5. The apparatus of claim 4, wherein the electro-pneumatic interface comprises a single cable with the calibration module plug installed at its distal end.

6. The apparatus of claim 4, wherein the calibration module plug comprises:
monitoring module interface connections for selective connection with the monitoring module; and
operating system interface connections for selective connection with either the monitoring module plug or a blank plug;
such that when the calibration module plug is installed on the frame and the blank plug is installed on the calibration module plug operating system interface connections, the pressure sensor is exposed to pressures generated in the calibration module; and
when the calibration module plug is installed on the frame and the monitoring module plug is installed on the calibration module plug operating system interface connections, the pressure sensor and the calibration module pressure outlets are exposed to pressures delivered by the measured and reference pressure lines.

7. A room air pressure monitoring apparatus comprising:
an operating system differential pressure monitoring module comprising pressure ports and at least one electrical connection;
at least one monitoring module plug attached to respective room and reference pressure lines and detachably securable on the monitoring module for selective connection of the pressure lines and the monitoring module pressure ports;
the monitoring module plug further comprising at least one electrical conductor, such that when the monitoring module plug is attached to the monitoring module, the monitoring module electrical connection is connected to an external electrical interface to enable functionality of the monitoring module in an operating mode;
a portable calibration module comprising pressure outlets and an electrical connection;
an electro-pneumatic interface connected at a proximate end to the calibration module pressure outlets and electrical connection and comprising at least one calibration module plug at a distal end, the calibration module plug adapted to be detachably secured to the monitoring module in place of the monitoring module plug to enable functionality of the monitoring module in a calibration mode.

8. The apparatus of claim 7, wherein the calibration module plug comprises:
monitoring module interface connections for selective connection with the monitoring module; and
operating system interface connections for selective connection with either the monitoring module plug or a blank plug;
such that when the calibration module plug attached to the monitoring module and the blank plug is installed on the calibration module plug operating system interface connections, the monitoring module is exposed to pressures generated in the calibration module and available at the calibration module pressure outlets; and
when the calibration module plug is installed on the monitoring module and the monitoring module plug is installed on the calibration module plug operating system interface connections, the monitoring module and the calibration module pressure outlets are exposed to pressures delivered by the room and reference pressure lines.

9. The apparatus of claim 7, further comprising:
a processor associated with the portable calibration module and operable to control a pressure generating element of the calibration module for delivering calibrating pressures to the calibration module pressure outlets;
an EPROM associated with the monitoring module and selectively connected to the processor via the electro-pneumatic interface; and
programmed instructions executable by the processor for interrogation of the EPROM to identify the monitoring module, for controlling operation of the pressure generating element during an automated calibration procedure, and for recording data on the EPROM to set zero and span values for the monitoring module as part of the automated calibration procedure.

10. A method of calibrating a pressure transducer having at least one transducer plug for detachably securing measured and reference pressure lines in fluid communication with the pressure transducer, the method comprising:
providing a portable calibration module comprising a pressure generator selectively operable to provide zero differential pressure or a full scale differential pressure;
removing the transducer plug from the transducer;
connecting an electro-pneumatic interface between the calibration module and the transducer by inserting a calibration module plug of the portable calibration module in place of the removed transducer plug;
using the calibration module to apply a zero differential pressure across the pressure lines, and setting a resulting output of the pressure transducer to a desired zero value; and
using the calibration module to apply a full scale differential pressure across the pressure lines, and setting a resulting output of the pressure transducer to a desired full scale value.

11. The method of claim 10, further comprising:
using the processor to interrogate an EPROM of the pressure transducer prior to applying the zero and full scale pressures to identify the pressure transducer; and
automatically selecting the full scale pressure in response to the identity of the pressure transducer.

12. The method of claim 10, further comprising:
using the processor to interrogate an EPROM of the pressure transducer prior to applying the zero and full scale pressures to identify the pressure transducer; and
automatically determining a required accuracy in response to the identity of the pressure transducer.

13. The method of claim 10, further comprising:
removing a blank from the calibration module plug and inserting in its place the removed transducer plug with the calibration module plug in place on the transducer, thereby exposing the calibration module to pressures delivered by the measured and reference pressure lines; and
recording data generated by the transducer and data coincidently generated by the calibration module in response to actual pressures delivered by the measured and reference pressure lines.

14. The method of claim 10, further comprising performing the steps of removing the transducer plug, connecting the electro-pneumatic interface, and using the calibration module without removing the transducer from its operational location and without removing any hard wired connection from the electrical terminal.

15. The method of claim 10, further comprising:
providing electrical continuity between an electrical connection of the transducer and an external electrical interface via a conductor of the transducer plug, whereby said continuity is broken upon removal of the transducer plug from the transducer; and
connecting the electrical connection of the transducer with an electrical connection of the calibration module via a conductor of the electro-pneumatic interface upon installation of the calibration module plug on the transducer in place of the transducer plug.

16. A portable calibration module for calibrating a pressure transducer for ambient air conditions in a room, the module comprising:
a calibration pressure source comprising pressure outlets;
a processor operatively connected for control of the calibration pressure source for delivery of controlled pressures to the respective pressure outlets;
an electro-pneumatic interface comprising fluid passages and an electrical conductor, a proximate end of the electro-pneumatic interface being fluidly connected to the pressure outlets and electrically connected to the processor;
a calibration module plug disposed at a distal end of the calibration module plug and adapted to be detachably secured to a pressure transducer being calibrated for fluidly connecting the transducer to the calibration pressure source and for electrically connecting the transducer to the processor.

17. The portable calibration module of claim 16, wherein the calibration module plug further comprises:
transducer interface connections disposed on a first side for detachably securing the calibration module plug to the pressure transducer; and
operating system interface connections disposed on a second side for detachably securing the calibration module plug to system operating pressure connections while the calibration module plug is secured to the pressure transducer.

18. The portable calibration module of claim 16, wherein the electro-pneumatic interface consists of a single integrated cable.

19. The portable calibration module of claim 16, further comprising code executable by the processor for:
interrogating the pressure transducer being calibrated to identify the transducer;
automatically completing a calibration procedure appropriate for the transducer in response to the identity of the transducer.
